(19) United States
(12) Patent Application Publication
(10) Pub. No.: US 2022/0118862 A1
(43) Pub. Date: Apr. 21, 2022

(54) VEHICLE LOWER PORTION STRUCTURE

(71) Applicant: TOYOTA JIDOSHA KABUSHIKI KAISHA, Aichi-ken (JP)

(72) Inventors: Yasuhiro HARA, Nagoya-shi (JP); Jumpei WATANABE, Nagakute-shi (JP); Norimasa KOREISHI, Miyoshi-shi (JP)

(21) Appl. No.: 17/469,881

(22) Filed: Sep. 9, 2021

(30) Foreign Application Priority Data
Oct. 16, 2020 (JP) 2020-174948

(51) Int. Cl. B60L 50/60; B62D 25/20; B62D 21/15

(52) U.S. Cl. CPC B60L 50/66; B62D 21/15; B62D 25/20

(57) ABSTRACT

A vehicle lower portion structure includes: framework members including a pair of first framework members respectively disposed at a left side and a right side in a vehicle width direction, and extending in a vehicle front-rear direction; a battery pack disposed between the first framework members; a connecting member that extends from the battery pack to at least one side in the vehicle front-rear direction, the connecting member connecting the battery pack with the framework members at the one side in the vehicle front-rear direction relative to the battery pack; and an electronic device installed at the connecting member.

### CROSS-REFERENCE TO RELATED APPLICATION

This application claims priority under 35 USC 119 from Japanese Patent Application No. 2020-174948 filed Oct. 16, 2020, the disclosure of which is incorporated by reference herein in its entirety.

### BACKGROUND

### Technical Field

The present invention relates to a vehicle lower portion structure.

### Related Art

Japanese Patent Application Laid-Open (JP-A) No. 2020-29134 proposes an electric car that is capable of autonomous running after a collision. In this autonomous driving vehicle or the like, a drive unit, an autonomous driving unit and the like are disposed in a protected area, and a washing unit and the like are disposed in crushable areas at vehicle outer sides relative to the protected area. Thus, at a time of collision, damage to the drive unit, autonomous driving unit and such that are necessary for autonomous running is suppressed.

In the electric car recited in JP-A No. 2020-29134, apart from the drive unit, autonomous driving unit and the like, a power unit that supplies electricity to sensors, a sensor unit and the like are disposed in a vehicle front portion or a vehicle rear portion. There is a room for improvement in stably supporting electronic devices such as compressors and the like while assuring space inside a cabin.

### SUMMARY

In consideration of the circumstances described above, the present disclosure provides a vehicle lower portion structure that may stably support electronic devices while assuring space inside a cabin.

A vehicle lower portion structure according to a first aspect of the present disclosure includes: framework members including a pair of first framework members respectively disposed at a left side and a right side in a vehicle width direction, and extending in a vehicle front-rear direction; a battery pack disposed between the first framework members; a connecting member that extends from the battery pack to at least one side in the vehicle front-rear direction, the connecting member connecting the battery pack with the framework members at the one side in the vehicle front-rear direction relative to the battery pack; and an electronic device installed at the connecting member.

In the vehicle lower portion structure according to the first aspect, the battery pack is disposed between, of the framework members of the vehicle, the first framework members that extend in the vehicle front-rear direction. At least the one side in the vehicle front-rear direction of the battery pack is connected with the framework members by the connecting member. Because the battery pack is connected with the framework members, even though via the connecting member, vehicle body stiffness is improved.

The electronic device is disposed at the connecting member that connects the battery pack with the framework members. A floor of a cabin provided above the battery pack and the electronic device may be lowered and space in the cabin may be assured.

Because the electronic device is installed at the connecting member that connects the large-mass battery pack with the framework members, the electronic device may be stably supported.

In a vehicle lower portion structure according to a second aspect of the present disclosure, in the vehicle lower portion structure according to the first aspect, the framework members further include a second framework member that connects a second region of each first framework member in the vehicle width direction at the one side in the vehicle front-rear direction relative to a first region of each first framework member at which the battery pack is disposed, and the connecting member connects the battery pack with the second framework member.

In the vehicle lower portion structure according to the second aspect, the second framework member that connects the second regions of the first framework members in the vehicle width direction is provided. Therefore, at a time of collision of the vehicle, a collision load that is applied to either of the first framework members is transmitted through the second framework member to the other of the first framework members and is dispersed. Thus, collision safety of the vehicle is improved.

The electronic device is disposed at the connecting member that connects the battery pack with the second framework member. Thus, the floor of the cabin provided above the battery pack and the electronic device may be lowered and space in the cabin may be further assured.

Because the electronic device is installed at the connecting member that connects the large-mass battery pack with the second framework member, the electronic device may be stably supported.

In a vehicle lower portion structure according to a third aspect of the present disclosure, in the vehicle lower portion structure according to the second aspect, the second regions of the first framework members are higher than the first regions at which the battery pack is disposed, the second framework member connects lower sides of the second regions of the first framework members with one another, and, in a vehicle front view, the electronic device and the battery pack substantially overlap in a vehicle vertical direction.

In the vehicle lower portion structure according to the third aspect, each second region of the first framework members is formed to be higher in the vehicle vertical direction than the each first region at which the battery pack is disposed. The second framework member connects the pair of first framework members with one another in the vehicle width direction at the lower sides of the second regions of the first framework members, where the first framework members are formed to be higher. The second framework member and the battery pack are connected by the connecting member.

Therefore, the connecting member is disposed at a position that is lower than the second regions of the first framework members. The battery pack that is disposed between the first regions of the first framework members and the electronic device that is installed at the connecting member substantially overlap in the vehicle vertical direction in the front view. That is, a height difference in the vehicle vertical direction between the battery pack and the electronic device is small. The floor of the cabin provided above the battery pack and the electronic device may be lowered and space in the cabin may be increased.

In a vehicle lower portion structure according to a fourth aspect of the present disclosure, in the vehicle lower portion structure according to the third aspect, a weakened portion is provided at the connecting member, the weakened portion being provided between the electronic device and the battery pack in the vehicle front-rear direction, and the connecting member being bent in the vehicle vertical direction at the weakened portion by a load applied from the one side in the vehicle front-rear direction.

In the vehicle lower portion structure according to the fourth aspect, when a collision load is applied to the vehicle from the one side in the vehicle front-rear direction, at which the connecting member is provided, the connecting member connecting the battery pack with the framework members bends in the vehicle vertical direction, starting from the weakened portion, and application of the collision load through the connecting member to the battery pack may be suppressed.

In addition, the electronic device installed at the connecting member is displaced in the vehicle vertical direction. Therefore, interference between the electronic device and the battery pack may be prevented or suppressed. Thus, damage to the battery pack associated with application of a collision load is prevented or suppressed.

In a vehicle lower portion structure according to a fifth aspect of the present disclosure, in the vehicle lower portion structure according to any of the first to fourth aspects, a pair of connecting members are respectively provided at the left side and the right side in the vehicle width direction, and the electronic device is installed at each connecting member.

In the vehicle lower portion structure according to the fifth aspect, electronic devices are installed at each connecting member that is provided at vehicle width direction left and right sides. Therefore, left-and-right balance of the vehicle may be assured even though the electronic devices are installed at the connecting members.

In a vehicle lower portion structure according to a sixth aspect of the present disclosure, in the vehicle lower portion structure according to any of the first to fifth aspects, the electronic device is a compressor.

In the vehicle lower portion structure according to the sixth aspect, because the compressor is installed at the connecting member that connects the large-mass battery pack with the framework members, the compressor, which is a vibrating body, may be stably supported.

In a vehicle lower portion structure according to a seventh aspect of the present disclosure, in the vehicle lower portion structure according to the sixth aspect, the compressor is at least one of a compressor for vehicle air conditioning or a compressor for cleaning vehicle sensors.

In the vehicle lower portion structure according to the seventh aspect, because the compressor for vehicle air conditioning or the compressor for vehicle sensor cleaning is installed at one or other of the connecting members, that compressor may be installed in the vehicle stably, in addition to which space in the cabin may be assured.

As described above, according to the vehicle lower portion structure according to the present disclosure, space in the cabin may be assured even while collision safety performance is improved.

### BRIEF DESCRIPTION OF THE DRAWINGS

Preferred embodiments will be described in detail based on the following figures, wherein:

FIG. 1 is a plan view schematically showing a vehicle lower portion structure according to a first exemplary embodiment;

FIG. 2 is a sectional diagram seen in a vehicle width direction (a sectional diagram cut along line 2-2 in FIG. 1) schematically showing a vehicle in which the vehicle lower portion structure according to the first exemplary embodiment is employed;

FIG. 3 is a magnified view of principal portions in FIG. 2;

FIG. 4 is a sectional diagram seen in the vehicle width direction schematically showing a rear portion side of the vehicle lower portion structure according to the first exemplary embodiment, which is a sectional diagram showing a deformed state at a time of rear collision of the vehicle;

FIG. 5 is a sectional diagram (a sectional diagram cut along line 6-6 in FIG. 6) schematically showing a compressor installation region of the vehicle lower portion structure according to the first exemplary embodiment;

FIG. 6 is a perspective view schematically showing the compressor installation region of the vehicle lower portion structure according to the first exemplary embodiment;

FIG. 7 is a sectional diagram (a sectional diagram cut along line 8-8 in FIG. 8) schematically showing a compressor installation region of a vehicle lower portion structure according to a second exemplary embodiment; and

FIG. 8 is a perspective view schematically showing the compressor installation region of the vehicle lower portion structure according to the second exemplary embodiment.

### DETAILED DESCRIPTION

### First Exemplary Embodiment

A vehicle lower portion structure according to a first exemplary embodiment is described with reference to the drawings. An arrow FR that is shown where appropriate in the drawings indicates a vehicle front side, an arrow UP indicates a vehicle upper side, and an arrow RH indicates a vehicle width direction right side. Below, where descriptions are given simply using the directions front, rear, upper, lower, left and right, unless otherwise specified, these represent the front-rear in the vehicle front-rear direction, upper and lower sides in the vehicle vertical direction, and left and right when facing in the vehicle front direction.

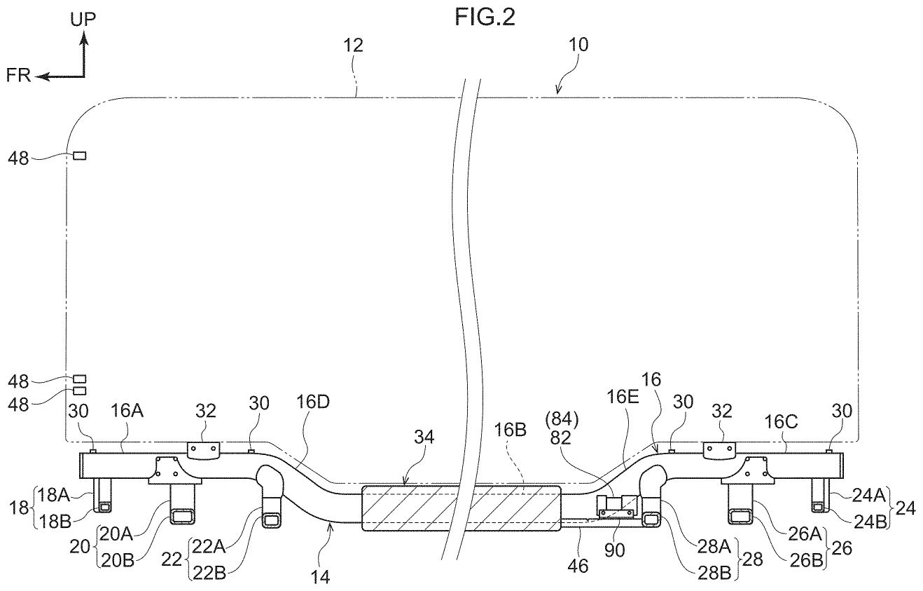

As shown in FIG. 2, the vehicle 10 in which the vehicle lower portion structure according to the present exemplary embodiment is employed is provided with a vehicle body 12 fabricated of steel and a frame 14 fabricated of steel, which supports the vehicle body 12. Thus, the vehicle 10 has a “frame structure”.

An external shape of the vehicle body 12 is a substantially cuboid box shape extending in the vehicle front-rear direction. The vehicle body 12 structures principal portions of a cabin in which a vehicle occupant rides. The vehicle body 12 and frame 14 are formed with structures that are basically symmetrical in the vehicle width direction and the vehicle front-rear direction.

The vehicle body 12 includes a roof portion, which is not shown in the drawings, a floor portion, which is not shown in the drawings, and four pillar portions, which are not shown in the drawings. The roof portion structures a vehicle upper side portion of the vehicle body 12. The floor portion structures a vehicle lower side portion of the vehicle body 12. The pillar portions link the roof portion with the floor portion in the vehicle vertical direction.

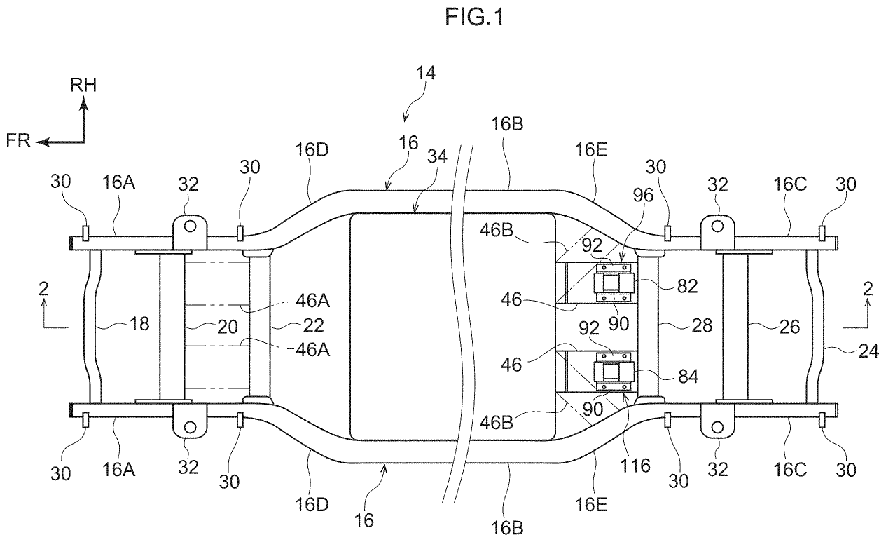

As shown in FIG. 1, a pair of side frame portions 16 of the frame 14 are disposed to be spaced apart in the vehicle width direction. At the front side of the side frame portions 16, the frame 14 is provided with a front side first cross portion 18, a front side second cross portion 20 and a front side third cross portion 22, which span between the pair of side frame portions 16. At the rear side of the side frame portions 16 that are disposed spaced apart in the vehicle width direction, the frame 14 is further provided with a rear side first cross portion 24, a rear side second cross portion 26 and a rear side third cross portion 28, which span between the pair of side frame portions 16.

Each side frame portion 16 as a whole extends in the vehicle front-rear direction and includes a front frame portion 16A, a main frame portion 16B, a rear frame portion 16C, a front kick portion 16D and a rear kick portion 16E. The side frame portion 16 is formed as a structure of which a cross section seen in the vehicle front-rear direction is a chamber.

More specifically, the front frame portion 16A structures a vehicle front side region of the side frame portion 16 and extends linearly in the vehicle front-rear direction. A pair of mount portions 30 that support the vehicle body 12 are provided at the front frame portion 16A, and a suspension tower 32 is provided at the front frame portion 16A between the mount portions 30. A shock absorber or the like, which is not shown in the drawings, is attached to the suspension tower 32.

The main frame portion 16B structures a vehicle front-rear direction middle side region of the side frame portion 16. The main frame portion 16B is disposed at the vehicle outer side at the vehicle lower side relative to the front frame portion 16A and extends linearly in the vehicle front-rear direction.

A battery pack 34 is disposed between the main frame portions 16B. The battery pack 34 is capable of supplying electric power to a power unit, which is not shown in the drawings. The battery pack 34 includes a battery pack case, which is not shown in the drawings, and plural battery pack modules, which are not shown in the drawings. The battery pack case structures an outer shell of the battery pack 34 and is fabricated of aluminum alloy. The battery pack modules are disposed inside the battery pack case.

Seen in the vehicle width direction, the battery pack 34 is disposed such that a major portion thereof is accommodated between upper faces and lower faces of the main frame portions 16B (see FIG. 2). The battery pack 34 is attached to the lower faces of the main frame portions 16B by fastening members, which are not shown in the drawings.

Each front kick portion 16D is interposed between the front frame portion 16A and the main frame portion 16B. Seen in the vehicle vertical direction, the front kick portion 16D projects to the vehicle width direction outer side and to the vehicle rear side from the front frame portion 16A. Seen in the vehicle width direction, the front kick portion 16D projects to the vehicle lower side and to the vehicle rear side from the front frame portion 16A.

The rear frame portion 16C and rear kick portion 16E are provided to be symmetrical in the vehicle front-rear direction with the front frame portion 16A and front kick portion 16D. Accordingly, the same reference symbols are applied for the rear frame portion 16C and rear kick portion 16E and detailed descriptions thereof are not given here.

The front side first cross portion 18 extends in the vehicle width direction and links the front frame portions 16A with one another at the vehicle lower side of the mount portions 30 that are at the vehicle front side. That is, as shown in FIG. 2, the front side first cross portion 18 includes a pair of support portions 18A, which extend downward from the corresponding front frame portions 16A, and a linking portion 18B, which links lower ends of the pair of support portions 18A with one another in the vehicle width direction. Thus, the front side first cross portion 18 links the pair of front frame portions 16A in the vehicle width direction at the lower side of the front frame portions 16A.

The front side second cross portion 20 extends in the vehicle width direction and links the front frame portions 16A with one another at the vehicle lower side of the suspension towers 32. That is, the front side second cross portion 20 includes a pair of support portions 20A, which extend downward from the corresponding front frame portions 16A, and a linking portion 20B, which links lower ends of the pair of support portions 20A with one another in the vehicle width direction. Thus, the front side second cross portion 20 links the pair of front frame portions 16A in the vehicle width direction at the lower side of the front frame portions 16A.

The front side third cross portion 22 extends in the vehicle width direction and links the front frame portions 16A with one another at boundary regions of the front frame portions 16A with the front kick portions 16D. That is, as shown in FIG. 2, the front side third cross portion 22 includes a pair of support portions 22A, which extend downward from the corresponding front frame portions 16A, and a linking portion 22B, which links lower ends of the pair of support portions 22A with one another in the vehicle width direction. Thus, the front side third cross portion 22 links the pair of front frame portions 16A in the vehicle width direction at the lower side of the front frame portions 16A.

The rear side first cross portion 24, rear side second cross portion 26 and rear side third cross portion 28 are provided to be symmetrical in the vehicle front-rear direction with the front side first cross portion 18, front side second cross portion 20 and front side third cross portion 22. That is, the rear side first cross portion 24, rear side second cross portion 26 and rear side third cross portion 28 include, respectively, support portions 24A, 26A and 28A and linking portions 24B, 26B and 28B. Thus, the rear side first cross portion 24, rear side second cross portion 26 and rear side third cross portion 28 respectively link the pair of rear frame portions 16C in the vehicle width direction at the lower side of the rear frame portions 16C.

As shown in FIG. 1, the rear side third cross portion 28 and the battery pack 34 are connected by a pair of reinforcing members 46, which extend in the vehicle front-rear direction. A vehicle front side end portion (below referred to as the front end) of each reinforcing member 46 is attached to a vehicle rear side end portion (below referred to as the rear end) of the battery pack 34. A rear end of the reinforcing member 46 is attached to the rear side third cross portion 28. Thus, the rear side third cross portion 28 is connected with the battery pack 34. A compressor for air conditioning 82 and a compressor for cleaning 84 are installed at upper portions of the reinforcing members 46.

—Reinforcing Members—

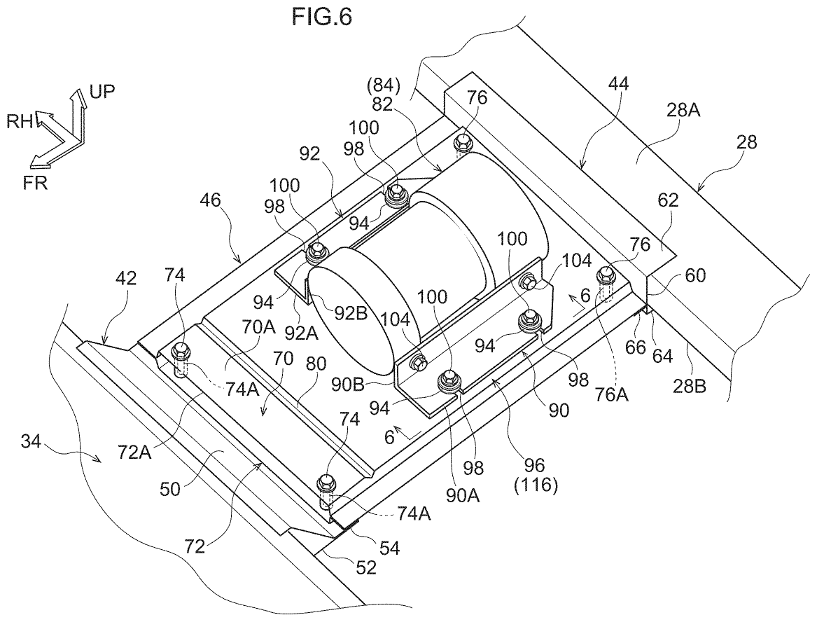

As shown in FIG. 6, each reinforcing member 46 is attached to the battery pack 34 via a first bracket 42 and is attached to the rear side third cross portion 28 via a second bracket 44. The reinforcing member 46 is equivalent to a “connecting member”.

The first bracket 42 is attached to the battery pack 34. The first bracket 42 includes a first member 50 that is attached to an upper face of the battery pack 34 and a second member 52 that is attached to a lower face of the battery pack 34. A front end of the first member 50 is joined to the upper face at the rear end side of the battery pack 34, and a front end of the second member 52 is joined to the lower face at the rear end side of the battery pack 34. A support portion 54 is formed by a rear end of the first member 50 and a rear end of the second member 52, which structure the first bracket 42, being joined together.

The second bracket 44 is attached to the rear side third cross portion 28. The second bracket 44 includes a base portion 60 that extends in the vehicle vertical direction, an upper face attachment portion 62 that extends to the vehicle rear side from an upper end of the base portion 60, a lower face attachment portion 64 that extends to the vehicle rear side from a lower end of the base portion 60, and a support portion 66 that extends in the vehicle front-rear direction from the base portion 60.

The upper face attachment portion 62 is joined to an upper face 28A of the rear side third cross portion 28, and the lower face attachment portion 64 is joined to a lower face 28B of the rear side third cross portion 28. Thus, the second bracket 44 is attached to the rear side third cross portion 28.

Each reinforcing member 46 includes an upper member 70 with a hat shape in cross section and a lower member 72 with a hat shape in cross section. The reinforcing member 46 is formed in a chamber structure by flange portions of the upper member 70 and flange portions of the lower member 72 being joined to one another.

The reinforcing member 46 extends in the vehicle front-rear direction and is fixed to the first bracket 42. A front end of a lower wall portion 72A of the lower member 72 is rested on the support portion 54 of the first bracket 42. Shaft portions 74A of bolts 74 are inserted from an upper wall portion 70A of the upper member 70 into holes penetrating through the lower wall portion 72A of the lower member 72. Weld nuts, which are not shown in the drawings, are provided at a lower face of the support portion 54 of the first bracket 42. The reinforcing member 46 is fixed to the first bracket 42 by the shaft portions 74A being fastened to the weld nuts.

A rear end of a lower face of the lower member 72 is rested on the support portion 66 of the second bracket 44. Shaft portions 76A of bolts 76 are inserted from an upper face of the upper member 70 into holes penetrating through the lower face of the lower member 72. Weld nuts, which are not shown in the drawings, are provided at a lower face of the support portion 66 of the second bracket 44. The reinforcing member 46 is fixed to the second bracket 44 by the shaft portions 76A being fastened to the weld nuts.

That is, the reinforcing members 46 are attached to the battery pack 34 and the rear side third cross portion 28 via the first brackets 42 and the second brackets 44, and the reinforcing members 46 link the battery pack 34 with the rear side third cross portion 28.

A weakened portion 80 is formed at the front end side of the upper wall portion 70A of the upper member 70 of each reinforcing member 46 (at the side in the vehicle front-rear direction at which the battery pack 34 is disposed relative to the compressor for air conditioning 82 or compressor for cleaning 84, which are described below). The weakened portion 80 is a “V” groove with a triangular shape in cross section that extends in the vehicle width direction.

—Compressor Installation Structures—

Attachment structures of the compressor for air conditioning 82 and compressor for cleaning 84 that are installed on the reinforcing members 46 structured as described above are described.

As shown in FIG. 6, the exterior of the compressor for air conditioning 82 is formed in a substantially cylindrical shape with a length direction in the vehicle front-rear direction. The compressor for air conditioning 82 is a scroll-type compressor.

The compressor for air conditioning 82 constitutes a portion of an air conditioning apparatus of the vehicle 10. The compressor for air conditioning 82 supplies a compressed coolant to a condenser, which is not shown in the drawings.

The compressor for air conditioning 82 is rested on the reinforcing member 46 that is disposed at the vehicle width direction right side relative to the center of the vehicle 10 in the vehicle width direction. That is, the compressor for air conditioning 82 is fixed to this reinforcing member 46 via a first attachment portion 96, which includes a support member 90, a support member 92 and rubber bushes 94.

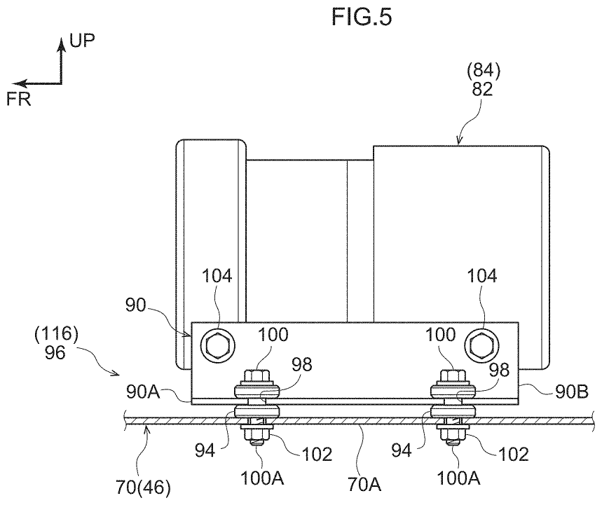

As shown in FIG. 5 and FIG. 6, the support member 90 is disposed on the reinforcing member 46 at the vehicle width direction left side of the compressor for air conditioning 82. The support member 90 is formed by bending of a plate fabricated of steel. The support member 90 includes a lower wall portion 90A and a vertical wall portion 90B. The lower wall portion 90A extends in the vehicle front-rear direction with the plate thickness direction in the vehicle vertical direction. The vertical wall portion 90B extends to the vehicle upper side from a periphery portion at the vehicle width direction right side of the lower wall portion 90A. The vertical wall portion 90B also extends in the vehicle front-rear direction.

A pair of slit portions 98 that are spaced apart in the vehicle front-rear direction are formed in the lower wall portion 90A. Each slit portion 98 is formed along the vehicle width direction at the lower wall portion 90A, in a state in which the slit portion 98 opens out at the vehicle width direction left side thereof. The rubber bushes 94 are fitted to the respective slit portions 98. A penetrating portion, which is not shown in the drawings, is formed in each rubber bush 94, penetrating through the rubber bush 94 in the vehicle vertical direction. Shaft portions 100A of bolts 100 are inserted into the rubber bushes 94 from the vehicle upper side thereof The shaft portions 100A are fastened to weld nuts 102 that are provided at the lower face of the upper wall portion 70A of the upper member 70 of the reinforcing member 46. Thus, the support member 90 is fixed to the reinforcing member 46.

A pair of penetrating portions, which are not shown in the drawings, are formed in the vertical wall portion 90B, spaced apart in the vehicle front-rear direction. Shaft portions, which are not shown in the drawings, of bolts 104 are inserted into these penetrating portions from the vehicle width direction left side. The shaft portions are fastened to female thread portions, which are not shown in the drawings, formed in a housing of the compressor for air conditioning 82. Thus, the vertical wall portion 90B is fixed to the compressor for air conditioning 82.

The support member 92 is disposed at the vehicle width direction right side of the compressor for air conditioning 82. The support member 92 is structured with mirror symmetry with the support member 90 as seen in the vehicle front-rear direction. A lower wall portion 92A of the support member 92 is fixed to the reinforcing member 46 via the rubber bushes 94 and bolts 100. A vertical wall portion 92B of the support member 92 is fixed to the compressor for air conditioning 82 via the bolts 104 (not shown in the drawings).

The compressor for cleaning 84 has basically the same structure as the compressor for air conditioning 82.

As shown in FIG. 1, the compressor for cleaning 84 is disposed on the reinforcing member 46 at the vehicle width direction left side relative to the center of the vehicle 10 in the vehicle width direction. The compressor for cleaning 84 is fixed to this reinforcing member 46 of the frame 14 in the same manner as the compressor for air conditioning 82 as shown in FIG. 5 and FIG. 6, via a second attachment portion 116 including others of the support member 90, the support member 92 and the plural rubber bushes 94 (not shown in the drawings).

The compressor for cleaning 84 supplies compressed air to sensors 48 disposed at a front portion of the vehicle (see FIG. 2). That is, by blowing compressed air at sensing surfaces of the sensors 48, the compressor for cleaning 84 removes dust adhering to the sensing surfaces.

—Operation—

In this vehicle lower portion structure, the battery pack 34 is disposed between the 1 side frame portions 16 that extend in the vehicle front-rear direction, and the rear side third cross portion 28 is connected with the rear end of the battery pack 34 by the reinforcing members 46 that extend in the vehicle front-rear direction. Thus, because the left and right sides of the battery pack 34 are connected with the side frame portions 16 and the battery pack 34 is connected with the rear side third cross portion 28 in the vehicle rear direction, vehicle body stiffness is improved.

Because the compressor for air conditioning 82 and compressor for cleaning 84 are supported at the reinforcing members 46 that connect the large-mass battery pack 34 with the rear side third cross portion 28, the compressor for air conditioning 82 and compressor for cleaning 84 are stably supported.

In particular, because the compressor for air conditioning 82 and compressor for cleaning 84 that are vibrating bodies are supported at the reinforcing members 46 via the rubber bushes 94 and the like, transmission of vibrations to the cabin via the frame 14 is prevented or suppressed.

In this vehicle lower portion structure, the front side first cross portion 18, front side second cross portion 20, front side third cross portion 22, rear side first cross portion 24, rear side second cross portion 26 and rear side third cross portion 28 (below referred to as the cross portions 18 to 28) that connect the side frame portions 16 in the vehicle width direction are provided.

Therefore, a collision load that is applied to one or other of the side frame portions 16 at a time of collision of the vehicle is transmitted through the cross portions 18 to 28 to the other of the side frame portions 16 and is dispersed. Thus, collision safety performance of the vehicle 10 is improved.

Because the battery pack 34 is connected to the side frame portions 16 via the reinforcing members 46 that extend in the vehicle front-rear direction and the rear side third cross portion 28, the battery pack 34 is stably retained.

In the vehicle lower portion structure, the battery pack 34 is disposed between the main frame portions 16B that are the middle portions in the vehicle front-rear direction of the pair of side frame portions 16. Meanwhile, the front frame portions 16A or rear frame portions 16C of the side frame portions 16 at the vehicle front side or the vehicle rear side relative to the main frame portions 16B are formed to be higher in the vehicle vertical direction than the main frame portions 16B. The front side third cross portion 22 and the rear side third cross portion 28 are disposed at the lower sides of the front frame portions 16A and rear frame portions 16C that are formed to be relatively higher within the side frame portions 16.

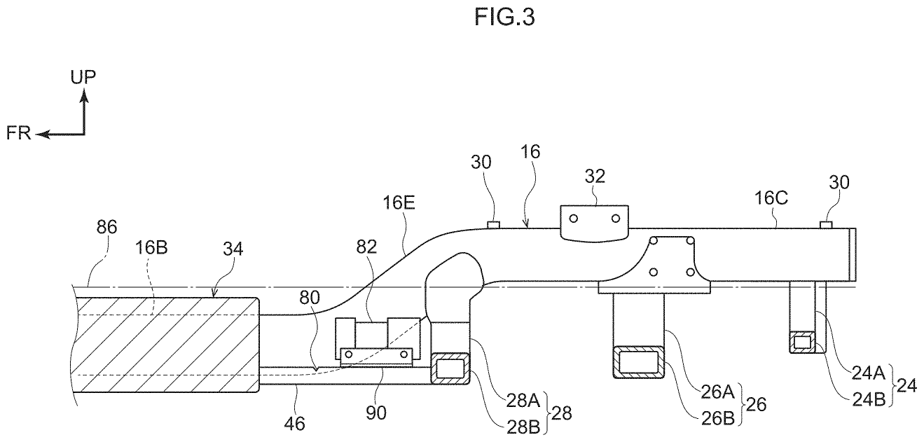

Therefore, as shown in FIG. 3, the reinforcing members 46 connecting the battery pack 34 with the rear side third cross portion 28 are disposed at low positions similar to the battery pack 34. Thus, the compressor for air conditioning 82 and compressor for cleaning 84 that are installed on the reinforcing members 46 overlap with the battery pack 34 in a vehicle front view. That is, even though the compressor for air conditioning 82 and compressor for cleaning 84 are installed on the reinforcing members 46, there is no large difference in vertical direction height (a step) between the compressor for air conditioning 82 and compressor for cleaning 84 and the battery pack 34.

Accordingly, a floor 86 of the cabin of the vehicle 10 (see FIG. 3) may be made flat through a region in which the compressor for air conditioning 82 and compressor for cleaning 84 are disposed, and the floor 86 may be lowered. Thus, space inside the cabin may be increased and flexibility of use of the cabin may be improved.

In particular in the present exemplary embodiment, the heights of the compressor for air conditioning 82 and compressor for cleaning 84 installed on the reinforcing members 46 are lower than the height of the battery pack 34 supported by the main frame portions 16B. In other words, viewed in the front-rear direction, the compressor for air conditioning 82 and compressor for cleaning 84 do not project upward relative to the battery pack 34.

Therefore, even though the compressor for air conditioning 82 and compressor for cleaning 84 are installed on the reinforcing members 46, raising of the floor 86 of the cabin o (see FIG. 3) or formation of a step at the floor 86 is not necessary.

In this vehicle lower portion structure, because the compressor for air conditioning 82 and compressor for cleaning 84 are respectively installed on the reinforcing members 46 provided as a left and right pair, left-and-right balance of the vehicle 10 may be assured even while the compressor for air conditioning 82 and compressor for cleaning 84 are stably installed on the reinforcing members 46.

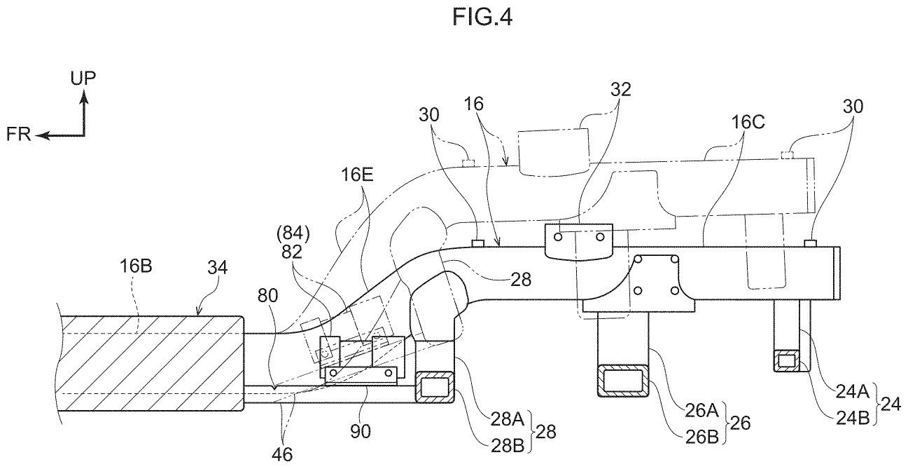

In this vehicle lower portion structure, as shown in FIG. 4, when the vehicle 10 is subjected to a rear collision and a collision load from the vehicle rear side toward the vehicle front side is applied to the vehicle 10, the collision load is applied to the battery pack 34 via the side frame portions 16 of the frame 14, the rear side third cross portion 28 and the reinforcing members 46. In this situation, the rear sides of the reinforcing members 46 bend upward, starting from the weakened portions 80, and application of the collision load through the reinforcing members 46 to the battery pack 34 is suppressed. In particular, because the rear sides of the reinforcing members 46 relative to the weakened portions 80 bend upward, the compressor for air conditioning 82 and compressor for cleaning 84 are displaced upward relative to the battery pack 34, and interference of the compressor for air conditioning 82 and compressor for cleaning 84 with the battery pack 34 is prevented or suppressed. That is, at a time of a rear collision of the vehicle 10, damage to the battery pack 34 is prevented or suppressed.

In FIG. 4, the solid lines illustrate a state before deformation, and the two-dot chain lines illustrate a state after deformation.

### Second Exemplary Embodiment

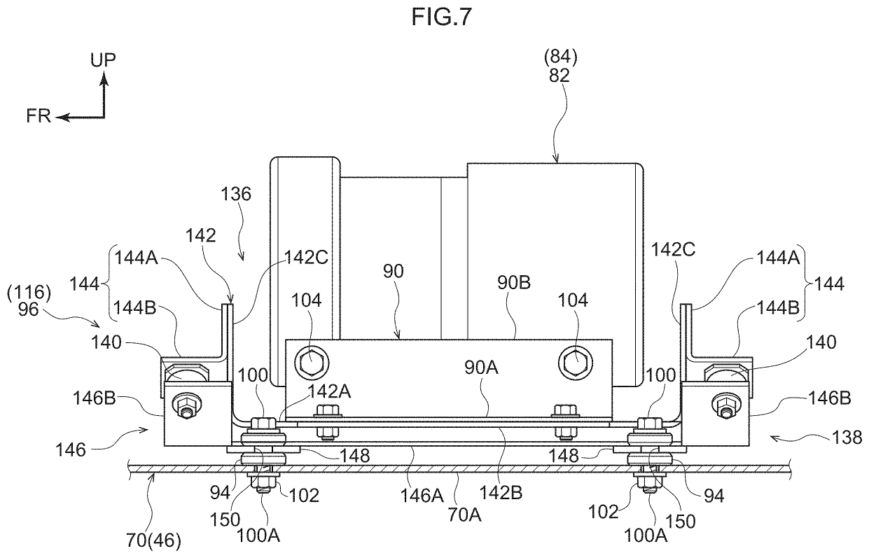

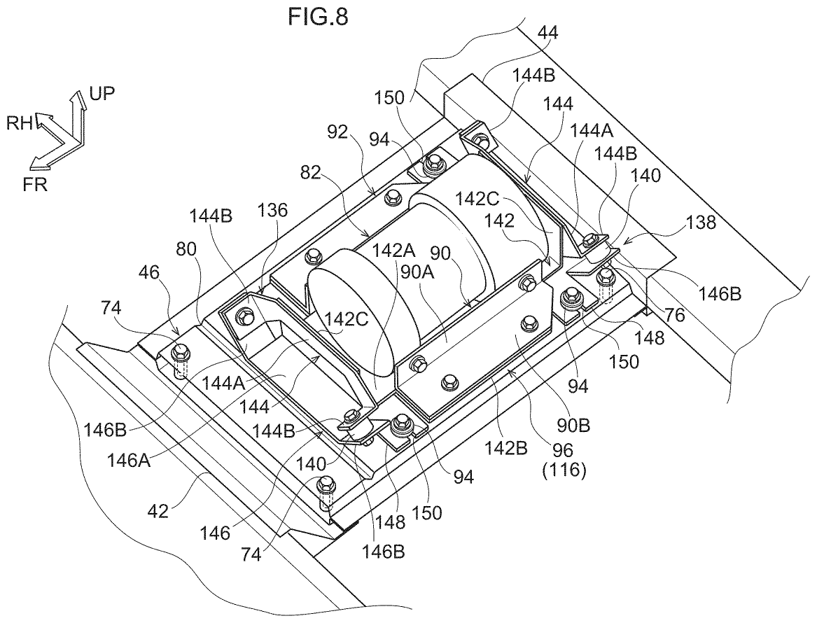

Below, the vehicle lower portion structure according to a second exemplary embodiment is described using FIG. 7 and FIG. 8. Structural portions that are the same as in the first exemplary embodiment are assigned the same reference symbols and are not described here.

A feature of the present exemplary embodiment is that the first attachment portion 96 and the second attachment portion 116 are structured to be capable of absorbing vibrations in the vehicle width direction that are caused by the compressor for air conditioning 82 and compressor for cleaning 84. In the present exemplary embodiment, the first attachment portion 96 and the second attachment portion 116 basically have the same structure. Accordingly, the structure of the first attachment portion 96 is taken as an example and described.

In the present exemplary embodiment, in addition to the support member 90, the support member 92 and the rubber bushes 94, the first attachment portion 96 is provided with an upper side support portion 136, a lower side support portion 138 and rubber bushes 140.

The upper side support portion 136 includes a base plate portion 142 and a pair of support plate portions 144. The base plate portion 142 is disposed at the vehicle lower side of the compressor for air conditioning 82 and is provided with a plate-shaped lower plate portion 142A, whose plate thickness direction is in the vehicle vertical direction. A pair of protruding portions 142B are provided at a vehicle front-rear direction middle portion of the lower plate portion 142A. The protruding portions 142B each protrude from the lower plate portion 142A in the vehicle width direction. The support member 90 is attached to the protruding portion 142B at the vehicle width direction left side and the support member 92 is attached to the protruding portion 142B at the vehicle width direction right side.

Respective vertical plate portions 142C, whose plate thickness directions are in the vehicle front-rear direction, protrude to the vehicle upper side from periphery portions at both vehicle front-rear direction sides of the lower plate portion 142A. The support plate portions 144 are attached to the respective vertical plate portions 142C. Seen in the vehicle vertical direction, the compressor for air conditioning 82 is disposed between the front and rear vertical plate portions 142C.

As shown in FIG. 7 and FIG. 8, each support plate portion 144 includes a main plate portion 144A, which constitutes a major portion of the support plate portion 144, and a pair of attachment plate portions 144B. The plate thickness direction of the main plate portion 144A is in the vehicle front-rear direction. Seen in the vehicle front-rear direction, the main plate portion 144A is formed in a “U”-shaped plate shape that widens toward the vehicle lower side.

The attachment plate portions 144B are formed as plate shapes that project forward or rearward from end portions at both sides in the vehicle width direction of the main plate portion 144A, projecting to the opposite side from the side thereof at which the compressor for air conditioning 82 is disposed. The plate thickness direction of each attachment plate portion 144B is specified to be a direction that is inclined in the vehicle vertical direction relative to the vehicle width direction. When the pair of attachment plate portions 144B are seen in the vehicle front-rear direction, a spacing between the pair of attachment plate portions 144B decreases toward the vehicle lower side. The support plate portion 144 is attached to the base plate portion 142 by welding or the like at a join portion, which is not shown in the drawings.

The lower side support portion 138 includes a base plate portion 146 and a pair of fixing plate portions 148. The base plate portion 146 is disposed at the vehicle lower side of the base plate portion 142 and is provided with a plate-shaped lower plate portion 146A, whose plate thickness direction is in the vehicle vertical direction.

Respective attachment plate portions 146B protrude from periphery portions at both sides in the vehicle width direction, the periphery portions are located at both sides in the vehicle front-rear direction end portions of the lower plate portion 146A. The attachment plate portions 146B are disposed at the vehicle lower sides of the attachment plate portions 144B and are specified with plate thickness directions in the same directions as the plate thickness directions of the attachment plate portions 144B.

The rubber bushes 140 are disposed between each attachment plate portion 146B and attachment plate portion 144B, in a state in which an axial direction of each rubber bush 140 is specified to be in the same direction as the plate thickness direction of the attachment plate portion 144B. Seen in the vehicle front-rear direction, an intersection point of the axis of each rubber bush 140 disposed at the vehicle width direction left side with the axis of each rubber bush 140 disposed at the vehicle width direction right side matches a rotation center of a moving scroll of the compressor for air conditioning 82.

Each fixing plate portion 148 is formed in a rectangular plate shape that extends in the vehicle width direction, with the plate thickness direction in the vehicle vertical direction. The fixing plate portion 148 is disposed at the vehicle lower side of the base plate portion 146 to be adjacent to the corresponding attachment plate portions 146B at the side of the attachment plate portions 146B at which the compressor for air conditioning 82 is disposed, as seen in the vehicle vertical direction. The fixing plate portion 148 is attached to the base plate portion 146 by welding or the like at a join portion, which is not shown in the drawings.

Slit portions 150 along the vehicle width direction are formed in both end portions of the fixing plate portion 148. One end of each slit portion 150 is opened out. The rubber bushes 94 are respectively fitted to the slit portions 150. The shaft portions 100A of the bolts 100 are inserted into the rubber bushes 94 from the vehicle upper side. The shaft portions 100A are fastened to the weld nuts 102 that are provided at the lower face of the upper wall portion 70A of the upper member 70 of the reinforcing member 46. Thus, the first attachment portion 96 is fixed to the reinforcing member 46.

According to this structure, because the structure is basically the same as in the first exemplary embodiment described above, the same operation and effects as in the first exemplary embodiment are provided.

In addition, in the present exemplary embodiment, because the rubber bushes 140 are disposed to be spaced apart in the vehicle width direction relative to the compressor for air conditioning 82, vibrations in the vehicle width direction that are produced from the compressor for air conditioning 82 may be absorbed by these rubber bushes 140. In the present exemplary embodiment, the second attachment portion 116 of the compressor for cleaning 84 may be provided with a plural number of the rubber bushes 140 (which are not shown in the drawings) similarly to the first attachment portion 96. Thus, vibrations in the vehicle width direction that are produced from the compressor for cleaning 84 may be absorbed by these rubber bushes 140.

=Supplementary Descriptions of the Above Exemplary Embodiments=

In the present exemplary embodiments, the compressor for air conditioning 82 and compressor for cleaning 84 are disposed on the reinforcing members 46, but this is not limiting. Alternative devices that are electronic devices may be disposed thus. These devices may be, for example, a converter and the like.

In the present exemplary embodiments, reinforcing members 46A may be disposed between the battery pack 34 and the front side third cross portion 22 (see FIG. 2). If the reinforcing members 46A are provided instead of the reinforcing members 46, the compressor for air conditioning 82 and the compressor for cleaning 84 are respectively rested on the reinforcing members 46A. If the reinforcing members 46 and the reinforcing members 46A are both provided, it is more desirable to install the compressor for air conditioning 82 and compressor for cleaning 84 on the reinforcing members 46 at the vehicle rear side, where more space is available. In this structure, because the front and rear of the battery pack 34 are connected with, respectively, the front side third cross portion 22 and the rear side third cross portion 28 by the reinforcing members 46A and 46, vehicle body stiffness may be further improved.

The reinforcing members 46 are structured to link the battery pack 34 with the rear side third cross portion 28, but structures are possible that link the battery pack 34 with the side frame portions 16 (see the reinforcing members 46B depicted by two-dot chain lines in FIG. 1).

In this set of exemplary embodiments, the weakened portion 80 provided at each reinforcing member 46 is a “V” groove formed in the upper wall portion 70A of the upper member 70, but this is not limiting. It is sufficient that the reinforcing member is bent in the vehicle vertical direction when a collision load is applied from the vehicle rear side. For example, a hole portion or the like may be formed in the upper wall portion 70A.

In the exemplary embodiments described above, the first attachment portion 96 and the second attachment portion 116 include the rubber bushes 94, but this is not limiting. That is, depending on specifications and the like of the vehicle 10, structures are possible in which the first attachment portion 96 and the second attachment portion 116 do not include the rubber bushes 94.

What is claimed is:

1. A vehicle lower portion structure comprising:
framework members including a pair of first framework members respectively disposed at a left side and a right side in a vehicle width direction, and extending in a vehicle front-rear direction;
a battery pack disposed between the first framework members;
a connecting member that extends from the battery pack to at least one side in the vehicle front-rear direction, the connecting member connecting the battery pack with the framework members at the one side in the vehicle front-rear direction relative to the battery pack; and
an electronic device installed at the connecting member.

2. The vehicle lower portion structure according to claim 1, wherein:
the framework members further include a second framework member that connects a second region of each first framework member in the vehicle width direction at the one side in the vehicle front-rear direction relative to a first region of each first framework member at which the battery pack is disposed, and
the connecting member connects the battery pack with the second framework member.

3. The vehicle lower portion structure according to claim 2, wherein:
the second regions of the first framework members are higher than the first regions at which the battery pack is disposed,
the second framework member connects lower sides of the second regions of the first framework members with one another, and,
in a vehicle front view, the electronic device and the battery pack substantially overlap in a vehicle vertical direction.

4. The vehicle lower portion structure according to claim 1, wherein a weakened portion is provided at the connecting member, the weakened portion being provided between the electronic device and the battery pack in the vehicle front-rear direction, and the connecting member being bent at the weakened portion in the vehicle vertical direction by a load applied from the one side in the vehicle front-rear direction.

5. The vehicle lower portion structure according to claim 1, wherein a pair of connecting members are respectively provided at the left side and the right side in the vehicle width direction, and the electronic device is installed at each connecting member.

6. The vehicle lower portion structure according to claim 1, wherein the electronic device is a compressor.

7. The vehicle lower portion structure according to claim 6, wherein the compressor is at least one of a compressor for vehicle air conditioning or a compressor for cleaning vehicle sensors.
